(19) United States
(12) Patent Application Publication
(10) Pub. No.: US 2026/0160889 A1
(43) Pub. Date: Jun. 11, 2026

(54) MULTI-CHANNEL SUB-BOTTOM PROFILER (SBP) ACQUISITION SYSTEM

(71) Applicant: FNV IP B.V., Leidschendam (NL)

(72) Inventor: Chad Allen PASTOR, Crowley, LA (US)

(21) Appl. No.: 18/970,503

(22) Filed: Dec. 5, 2024

(51) Int. Cl. G01S 15/89; G01S 15/74

(52) U.S. Cl. CPC G01S 15/8902; G01S 15/74

(57) ABSTRACT

Described are systems and techniques for marine surveying. A sonar array can transmit a sonar pulse according to a distance-based transmission rate, and a measurement cycle of a sub-bottom profiler (SBP) system on an underwater vehicle can be performed in response. An SBP transmitter can transmit an acoustic pulse triggered based on transmission of the sonar pulse by the sonar array. A plurality of SBP receivers can receive respective acoustic measurement data corresponding to reflections of the acoustic pulse, where the plurality of receivers are rigidly coupled to the underwater vehicle and arranged in a linear configuration with the transmitter of the SBP system. Unlocking insights from Geo-Data, the present invention further relates to improvements in sustainability and environmental developments: together we create a safe and livable world.

### FIELD

Aspects of the present disclosure generally relate to underwater sensing and/or acoustic surveying acquisition systems and methods of use thereof. For example, aspects of the present disclosure are related to systems and techniques for an orientation and/or motion compensated multi-channel sub-bottom profiler (SBP) including one or more transmitters and a plurality of receivers arranged in an along track direction, where the SBP transmitter(s) can be configured to use a trigger signal associated with a synthetic aperture sonar (SAS) included in a same survey vessel as the multi-channel SBP. Unlocking insights from Geo-Data, the present invention further relates to improvements in sustainability and environmental developments: together we create a safe and livable world.

### BACKGROUND

Marine surveying and/or other geophysical surveying performed in a marine or underwater environment can involve the collection of acoustic (e.g., sonar) mapping information. Mapping the ocean-floor and/or other sub-surface regions within a marine or underwater environment poses various challenges, both from a technical and an economic perspective. Approximately 70% of the earth surface is covered by ocean, and only as much as 20% of the ocean floor has been explored and mapped in detail, according to some estimates. Mapping of a submerged surface and/or detection of structures or formations that are present in, on, and/or near such surfaces may be performed by a floating platform (e.g. a vessel) and/or an underwater platform (e.g., a towfish or other towed apparatus, a remote operated vehicle (ROV), a remote operated towed vehicle (ROTV) an autonomous underwater vehicle (AUV), an uncrewed underwater vessel (UUV), etc.). As used herein, the term “underwater vehicle” may refer to a floating platform, an underwater platform, and/or various combinations thereof. Marine and other underwater surveying operations can be performed using various acoustic sensors and acoustic pulse-based mapping techniques. For instance, various types of active sonar sensors and mapping techniques can be used to obtain various types of underwater survey and/or mapping data.

Side-scan sonar (SSS) arrays can be used to map seafloor surfaces on either lateral side of an underwater vehicle traveling through an area of interest (e.g., the region of seafloor surface being mapped). Side-scan sonar transducer arrays can be configured to emit conical or fan-shaped acoustic pulses from the underwater vehicle down toward the seafloor, often across a relatively wide angle that is oriented perpendicular to the path of the SSS transducer array through the water. In some examples, synthetic aperture sonar (SAS) techniques can be used to increase the spatial resolution of sonar data. For example, SAS techniques can be used for and/or implemented by a side-scan sonar system to increase the along-track resolution without increasing the array length of the SSS transducer array.

Marine and underwater surveying operations may combine a first sonar or acoustic system for mapping or imaging the seafloor surface, with a second sonar or acoustic system for mapping a profile of the layers below the seafloor surface (e.g., referred to as the “sub-bottom”). For example, an underwater vehicle may include an SSS or SAS transducer array for mapping the seafloor surface, and may include a sub-bottom profiler (SBP) for mapping the profile of the sub-bottom layers below the seafloor surface. The SSS or SAS survey of the seafloor can be performed concurrently, or within the same time window, as the SBP survey of the sub-bottom profile. Both the SSS or SAS transducer array and the SBP system operate based on transmitting one or more acoustic (e.g., sonar) pulses, and measuring the corresponding reflection information of the pulse interacting with the respective target being mapped (e.g., the SSS or SAS transducer array measures corresponding reflections from the seafloor surface, while the SBP system measures reflections from the sub-bottom layers below the seafloor surface). Interference can occur when transmissions of one system overlap with receptions of the other system. For example, interference can occur if the SBP system transmits a pulse while the SSS or SAS transducer array is receiving reflections of an earlier SSS/SAS pulse. Similarly, interference can occur if the SSS or SAS transducer array transmits pulses while the SBP system is receiving reflections of an earlier SBP pulse.

There is thus a need to address at least one of the problems described above by providing a solution for performing SBP surveying operations and additional sonar surveying operations (e.g., SAS, SSS, etc.) by an underwater vehicle that includes both an SBP and an additional sonar transducer system, such as an SSS-based sonar and/or an SAS-based sonar transducer system.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some examples, systems and techniques are described for a multi-channel sub-bottom profiler (SBP) acquisition system with orientation and/or motion compensation for each SBP channel of the multiple SBP channels. The multiple SBP channels can correspond to multiple SBP receivers configured to receive reflected acoustic pulses transmitted by an SBP transmitter. For example, each SBP channel of the multiple SBP channels can correspond to a respective SBP receiver of the multiple SBP receivers. In some cases, orientation and/or motion compensation can be applied during post-processing performing for the SBP reflection data measured by each SBP receiver on the corresponding SBP channel. For example, the orientation and/or motion compensation be implemented based on the particular location of each SBP receiver on the underwater vehicle, and measured sensor information corresponding to the motion and/or orientation of the underwater vehicle at the time of the SBP data acquisition. The motion and/or orientation sensor data used for the post-processing multi-channel SBP compensation can include roll, pitch, yaw, and/or other inertial or kinematic information corresponding to the underwater vehicle and multi-channel SBP system including the multiple SBP receivers. In some cases, the post-processing multi-channel SBP orientation and/or motion compensation can be performed based on sensor data obtained from an inertial navigation system (INS) associated with the underwater vehicle or otherwise rigidly coupled to the multi-channel SBP system.

In one illustrative example, a method can include: transmitting a sonar pulse using a sonar transducer array, wherein the sonar transducer array transmits the sonar pulse according to a first transmission rate, and wherein the first transmission rate corresponds to a configured distance along a seafloor surface; and performing a measurement cycle of a sub-bottom profiler (SBP) system in response to transmission of the sonar pulse by the sonar transducer array, wherein the SBP system is associated with an underwater vehicle, and wherein performing the measurement cycle comprises: transmitting, using a transmitter of the SBP system, an acoustic pulse, wherein the transmitter of the SBP system is triggered based on the transmission of the sonar pulse by the sonar transducer array; and obtaining, using a plurality of receivers of the SBP system, respective acoustic measurement data corresponding to reflections of the acoustic pulse, wherein the plurality of receivers of the SBP system are rigidly coupled to the underwater vehicle and arranged in a linear configuration with the transmitter of the SBP system.

In some aspects, the method further comprises: obtaining multi-channel SBP measurement data corresponding to a plurality of measurement cycles of the SBP system, wherein each channel of the multi-channel SBP measurement data includes the respective acoustic measurement data obtained during the plurality of measurement cycles using a respective receiver of the plurality of receivers of the SBP system.

In some aspects, the method further comprises: obtaining inertial measurement data associated with the underwater vehicle, wherein at least a portion of the inertial measurement data corresponds to one or more movements of the underwater vehicle during the measurement cycle of the SBP system; correlating the multi-channel SBP measurement data with the inertial measurement data to determine respective motion compensation information for each channel of the multi-channel SBP measurement data; and processing the multi-channel SBP measurement data according to the respective motion compensation information for each channel, to thereby generate a processed sub-bottom profile for the plurality of measurement cycles of the SBP system.

In some aspects, a spatial measurement density of the processed sub-bottom profile is greater than a spatial transmission density associated with the SBP system transmitting one acoustic pulse within each measurement cycle of the plurality of measurement cycles.

In some aspects, the spatial measurement density of the processed sub-bottom profile is greater than the spatial transmission density by a factor equal to a quantity of receivers included in the plurality of receivers of the SBP system.

In some aspects, a spatial resolution of the processed sub-bottom profile is equal to the configured distance along the seafloor surface divided by a quantity of receivers included in the plurality of receivers of the SBP system.

In some aspects, the method further comprises: determining, for each respective measurement cycle of the plurality of measurement cycles, a normalized horizontal plane corresponding to the linear configuration of the plurality of receivers and the transmitter of the SBP system during the respective measurement cycle, wherein the normalized horizontal plane is determined based on the inertial measurement data associated with the underwater vehicle.

In some aspects, processing the multi-channel SBP measurement data according to the respective motion compensation information for each channel includes: using the respective motion compensation information for each channel to align the acoustic measurement data for each receiver of the SBP system to the normalized horizontal plane determined for the respective measurement cycle.

In some aspects, the respective motion compensation information for each channel of the multi-channel SBP measurement data is indicative of: a corresponding three-dimensional (3D) coordinate for the respective receiver of the SBP system at a time when the respective receiver obtained the respective acoustic measurement data for each measurement cycle of the plurality of measurement cycles.

In some aspects, the inertial measurement data is obtained using an inertial navigation system (INS) of the underwater vehicle; and the respective motion compensation information for each channel is determined based on projecting the inertial measurement data from a position of the INS on the underwater vehicle to a corresponding position on the underwater vehicle of the respective receiver of the SBP system associated with each channel.

In some aspects, a duration of the measurement cycle of the SBP system is less than or equal to a duration of a transmission cycle of the sonar transducer array; and the transmission cycle of the sonar transducer array corresponds to successive sonar pulse transmissions by the sonar transducer array according to the first transmission rate.

In some aspects, the method further comprises: obtaining sonar measurement data based on using the sonar transducer array to receive one or more reflections of the transmitted sonar pulse, wherein the sonar transducer array receives the one or more reflections of the transmitted sonar pulse at a time after the transmission of the acoustic pulse by the transmitter of the SBP system is completed.

In some aspects, the sonar transducer array comprises a synthetic aperture sonar (SAS) transducer array oriented in an along-track direction corresponding to a direction of travel of the underwater vehicle.

In some aspects, a periodicity between successive measurement cycles of the SBP system corresponds to a length of the sonar transducer array.

In some aspects, the sonar transducer array and the SBP system are oriented perpendicular to one another on the underwater vehicle.

In some aspects, the underwater vehicle comprises at least one of: an underwater vessel, an underwater platform, or an uncrewed underwater vessel (UUV).

In some aspects, the underwater vehicle comprises a remote operated vehicle (ROV), a remote operated towed vehicle (ROTV), or an autonomous underwater vehicle (AUV).

In some aspects, the first transmission rate of the sonar transducer array is based on the configured distance along the seafloor surface and a survey speed of the underwater vehicle.

In some aspects, the survey speed is greater than 4 meters per second.

In some aspects, the plurality of receivers of the SBP system and the transmitter of the SBP system are arranged in the linear configuration oriented along an along-track axis of the underwater vehicle.

In another illustrative example, a system is provided, the system comprising at least one processor and a memory storing instructions which, when executed by the at least one processor, cause the at least one processor to: transmit a sonar pulse using a sonar transducer array, wherein the sonar transducer array transmits the sonar pulse according to a first transmission rate, and wherein the first transmission rate corresponds to a configured distance along a seafloor surface; and perform a measurement cycle of a sub-bottom profiler (SBP) system in response to transmission of the sonar pulse by the sonar transducer array, wherein the SBP system is associated with an underwater vehicle, and wherein performing the measurement cycle comprises: transmitting, using a transmitter of the SBP system, an acoustic pulse, wherein the transmitter of the SBP system is triggered based on the transmission of the sonar pulse by the sonar transducer array; and obtaining, using a plurality of receivers of the SBP system, respective acoustic measurement data corresponding to reflections of the acoustic pulse, wherein the plurality of receivers of the SBP system are rigidly coupled to the underwater vehicle and arranged in a linear configuration with the transmitter of the SBP system.

In another illustrative example, provided is a non-transitory computer-readable storage medium comprising instructions stored thereon which, when executed by at least one processor, causes the at least one processor to: transmit a sonar pulse using a sonar transducer array, wherein the sonar transducer array transmits the sonar pulse according to a first transmission rate, and wherein the first transmission rate corresponds to a configured distance along a seafloor surface; and perform a measurement cycle of a sub-bottom profiler (SBP) system in response to transmission of the sonar pulse by the sonar transducer array, wherein the SBP system is associated with an underwater vehicle, and wherein performing the measurement cycle comprises: transmitting, using a transmitter of the SBP system, an acoustic pulse, wherein the transmitter of the SBP system is triggered based on the transmission of the sonar pulse by the sonar transducer array; and obtaining, using a plurality of receivers of the SBP system, respective acoustic measurement data corresponding to reflections of the acoustic pulse, wherein the plurality of receivers of the SBP system are rigidly coupled to the underwater vehicle and arranged in a linear configuration with the transmitter of the SBP system.

In another illustrated example, an apparatus for marine surveying is provided. The apparatus includes: means for transmitting a sonar pulse using a sonar transducer array, wherein the sonar transducer array transmits the sonar pulse according to a first transmission rate, and wherein the first transmission rate corresponds to a configured distance along a seafloor surface; and means for performing a measurement cycle of a sub-bottom profiler (SBP) system in response to transmission of the sonar pulse by the sonar transducer array, wherein the SBP system is associated with an underwater vehicle, and wherein performing the measurement cycle comprises: transmitting, using a transmitter of the SBP system, an acoustic pulse, wherein the transmitter of the SBP system is triggered based on the transmission of the sonar pulse by the sonar transducer array; and obtaining, using a plurality of receivers of the SBP system, respective acoustic measurement data corresponding to reflections of the acoustic pulse, wherein the plurality of receivers of the SBP system are rigidly coupled to the underwater vehicle and arranged in a linear configuration with the transmitter of the SBP system.

In another illustrative example, provided is can underwater vehicle for marine surveying, the underwater vehicle comprising: a sub-bottom profiler (SBP) transmitter included in a multi-receiver SBP system of the underwater vehicle; and a plurality of SBP receivers included in the multi-receiver SBP system of the underwater vehicle, wherein the plurality of SBP receivers are rigidly coupled to the underwater vehicle and arranged in a linear configuration positioned longitudinally along a direction of travel of the underwater vehicle.

In some aspects, the underwater vehicle further comprises: a flat panel array rigidly coupled to an exterior surface of the underwater vehicle, wherein the flat panel array extends longitudinally along the direction of travel of the underwater vehicle, and wherein the plurality of SBP receivers are attached to the flat panel array in the linear configuration.

In some aspects, the flat panel array comprises a rigid housing for the plurality of SBP receivers of the multi-receiver SBP system.

In some aspects, the plurality of SBP receivers are integral with an exterior surface of the underwater vehicle based on the plurality of SBP receivers being rigidly coupled to the underwater vehicle.

In some aspects, the underwater vehicle further comprises: a controller associated with the multi-receiver SBP system, wherein the controller is configured to perform a measurement cycle of the SBP system in response to transmission of a sonar pulse by a sonar transducer array having a first transmission rate corresponding to a configured distance along a seafloor surface.

In some aspects, the sonar transducer array comprises a synthetic aperture sonar (SAS) transducer array or a side scan sonar (SSS) transducer array.

In some aspects, the controller is included in the multi-receiver SBP system; and to perform the measurement cycle of the SBP system, the controller is configured to: trigger the SBP transmitter to emit an acoustic pulse, wherein the controller triggers the SBP transmitter in response to the transmission of the sonar pulse by the sonar transducer array.

In some aspects, the sonar transducer array is included in the underwater vehicle.

In some aspects, the plurality of SBP receivers are configured to obtain respective acoustic measurement data corresponding to reflections of the acoustic pulse.

In some aspects, the underwater vehicle further comprises at least one of an inertial navigation system (INS) or a plurality of inertial sensors; and the controller is configured to obtain inertial measurement data associated with the underwater vehicle from the at least one of the INS or the plurality of inertial sensors, wherein at least a portion of the inertial measurement data corresponds to one or more movements of the underwater vehicle during the measurement cycle of the SBP system.

In some aspects, the underwater vehicle comprises an autonomous underwater vehicle (AUV), a remote operated vehicle (ROV), or a remote operated towed vehicle (ROTV).

In some aspects, wherein the plurality of SBP receivers comprises four or more SBP receivers.

In some aspects, the SBP transmitter is included in the linear configuration.

In some aspects, a first subset of the plurality of SBP receivers is positioned aft of the SBP transmitter within the linear configuration; and a second subset of the plurality of SBP receivers is positioned fore of the SBP transmitter within the linear configuration.

In some aspects, the SBP transmitter is positioned at a midpoint of the linear configuration; and a quantity of SBP receivers included in the first subset is equal to a quantity of SBP receivers included in the second subset.

In some aspects, a quantity of SBP receivers included in the first subset is greater than a quantity of SBP receivers included in the second subset.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating examples of acoustic (e.g., sonar) pulses transmitted by a side-scan sonar (SSS) transducer array, and examples of acoustic (e.g., sonar) pulses transmitted by a synthetic aperture sonar (SAS) transducer array, in accordance with some examples;

FIG. 2 is a diagram illustrating an example perspective view of an underwater vehicle including a sonar array (e.g., SSS array, SAS array, etc.) and a sub-bottom profiler (SBP) system including an SBP transmitter and an SBP receiver, in accordance with some examples;

FIG. 3 is a diagram illustrating an example perspective view of an underwater vehicle including a sonar array (e.g., SSS array, SAS array, etc.) and a multi-channel SBP system including an SBP transmitter and a plurality of SBP receivers arranged according to a first configuration of the multi-channel SBP system, in accordance with some examples;

FIG. 4 is a diagram illustrating an example perspective view of an underwater vehicle including a sonar array (e.g., SSS array, SAS array, etc.) and a multi-channel SBP system including an SBP transmitter and a plurality of SBP receivers arranged according to a second configuration of the multi-channel SBP system, in accordance with some examples;

FIG. 5 is a flow diagram illustrating an example of a process for performing an acoustic survey using a sampling periodicity of sound velocity profile measurements adjusted according to a time interval determined based on the local solar noon time value, in accordance with some examples; and

FIG. 6 is a block diagram illustrating an example of a computing system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

It will be appreciated that for simplicity and clarity of illustration, where appropriate, reference numerals have been repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Systems, apparatuses, processes (also referred to as methods), and computer-readable media (collectively referred to as “systems and techniques”) are described herein for an orientation and/or motion compensated multi-channel sub-bottom profiler (SBP) including one or more transmitters and a plurality of receivers arranged in an along track direction, where the SBP transmitter(s) can be configured to use a trigger signal associated with a synthetic aperture sonar (SAS) included in a same survey vessel (e.g., an underwater vehicle, also referred to as an underwater survey vehicle or underwater survey vessel, etc.) as the multi-channel SBP.

The multi-channel sub-bottom profiler (SBP) can include one or more transmitters (e.g., also referred to as one or more “SBP transmitters”) and a plurality of receivers (e.g., also referred to as a plurality of “SBP receivers”) arranged in an along track direction of a underwater vehicle, survey platform, survey apparatus, etc. In some aspects, the term survey vessel can be used to various refer to one or more of a surface survey vessel, ship, boat, vehicle, etc. ; a sub-surface or underwater vessel or vehicle; a tethered or towed survey vehicle or apparatus; a non-tethered survey vehicle or apparatus; a floating platform (e.g. a vessel) and/or an underwater platform (e.g., a towfish or other towed apparatus, a remote operated vehicle (ROV), an autonomous underwater vehicle (AUV), an uncrewed underwater vessel (UUV), etc.).

In one illustrative example, the underwater vehicle includes a synthetic aperture sonar (SAS) transducer array and an SBP profiler system comprising one or more SBP transmitters and a plurality of SBP receivers. In some aspects, the SBP transmitter(s) can be configured to use a trigger signal associated with a synthetic aperture sonar (SAS) included in a same underwater vehicle as the multi-channel SBP. In some aspects, the sonar transducer array transmits sonar pulses according to a first transmission rate, and the transmission of the sonar pulse(s) by the sonar transducer array can be used to trigger the multi-channel SBP system to transmit an acoustic pulse (e.g., using the one or more SBP transmitters) and subsequently measure one or more reflections of the acoustic pulse from the layers below the seafloor surface (e.g., the sub-bottom profile). The multi-channel SBP system can be triggered to transmit the acoustic pulse prior to the beginning of measurements of the reflected sonar pulse transmitted by the SAS or other sonar transducer array of the underwater vehicle. For example, the multi-channel SBP system can transmit the acoustic pulse immediately after or following the transmission of the sonar pulse by the SAS or other sonar transducer array. In some examples, a delay or lag between the transmission of the sonar pulse by the SAS or other transducer array, and the transmission of the acoustic pulse by the one or more SBP transmitters of the multi-channel SBP system, can correspond to a propagation time for a trigger signal generated in response to the transmission of the sonar pulse to reach a control system or controller that causes the one or more SBP transmitters to transmit the acoustic pulse in response to the trigger signal from the transmission of the sonar pulse by the SAS or other sonar transducer array.

In some cases, the first transmission rate used by the SAS or other sonar transducer array can correspond to a configured distance along a seafloor surface. For example, the sonar pulse can be a sonar pulse that is transmitted based on a distance traveled along the seafloor surface by the underwater vehicle. In some cases, the sonar pulse can be transmitted by a transmitter included in the sonar transducer array. The sonar transducer array can be a side-scan sonar (SSS) transducer array, a synthetic aperture sonar (SAS) transducer array, an SSS transducer array configured for SAS operations, etc., among various other active acoustic sensor arrays and/or echosounders that operate based on transmitting sound and analyzing a resultant reflected signal from a target or area.

Further aspects of the disclosure are described below, with reference to the figures.

As noted above, marine and underwater surveying operations may combine a first sonar or acoustic system for mapping or imaging the seafloor surface, with a second sonar or acoustic system for mapping a profile of the layers below the seafloor surface (e.g., referred to as the “sub-bottom”). For example, an underwater vehicle may include an SSS or SAS transducer array for mapping the seafloor surface, and may include a sub-bottom profiler (SBP) for mapping the profile of the sub-bottom layers below the seafloor surface. The SSS or SAS survey of the seafloor can be performed concurrently, or within the same time window, as the SBP survey of the sub-bottom profile. Both the SSS or SAS transducer array and the SBP system operate based on transmitting one or more acoustic (e.g., sonar) pulses, and measuring the corresponding reflection information of the pulse interacting with the respective target being mapped (e.g., the SSS or SAS transducer array measures corresponding reflections from the seafloor surface, while the SBP system measures reflections from the sub-bottom layers below the seafloor surface).

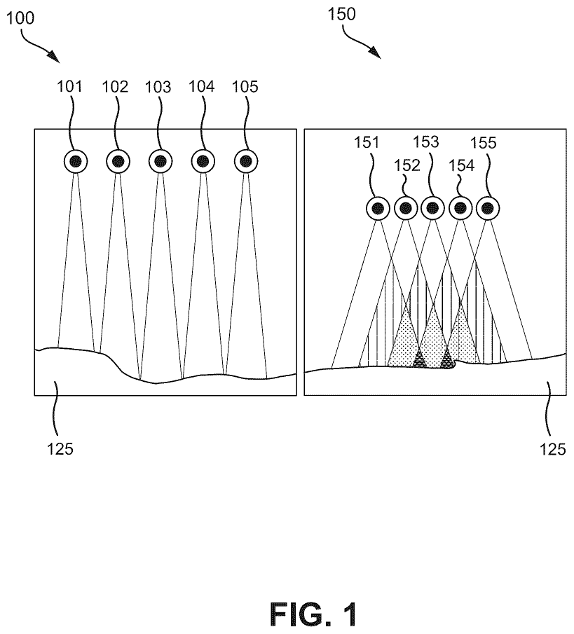

For example, FIG. 1 is a diagram illustrating an example profile view 100 of acoustic (e.g., sonar) pulses transmitted by a side-scan sonar (SSS) transducer array, and an example profile view 150 of acoustic (e.g., sonar) pulses transmitted by a synthetic aperture sonar (SAS) transducer array, in accordance with some examples. In some aspects, the example profile view 100 corresponds to an example where an SSS transducer array is used to map a seafloor surface 125, based on a plurality of pulses each transmitted from a different (e.g., respective) location 101, 102, 103, 104, 105, . . . , etc. of the SSS transducer array (e.g., as the SSS transducer array is moved through the water by an underwater vehicle, etc.) Similarly, the example profile view 150 may correspond to an example where an SAS transducer array is used to map the seafloor surface 125, based on a plurality of pulses transmitted from the respective SAS array locations 151, 152, 153, 154, 155, . . . , etc., as the SAS transducer array is moved through the water by an underwater vehicle.

In some examples, side-scan sonar arrays can be used to map seafloor surfaces (e.g., surfaces, locations, areas, regions, etc., on or within the seafloor 125 of FIG. 1, etc.) on either lateral side of an underwater vehicle traveling through an area of interest (e.g., above the region of seafloor surface being mapped). Side-scan sonar transducer arrays can be configured to emit conical or fan-shaped acoustic pulses from the underwater vehicle down toward the seafloor 125, often across a relatively wide angle that is oriented perpendicular to the path of the SSS transducer array through the water. For example, when the SSS transducer array is coupled to an underwater vehicle, the SSS transducer array can be configured to emit conical or fan-shaped pulses that are substantially perpendicular to the direction of travel of the underwater vehicle (e.g., also referred to as a “cross-track” direction of the underwater vehicle and/or transducer array; with an “along track” direction corresponding to the direction of travel). For instance, in the example of FIG. 1, the SSS transducer array can emit a first sonar pulse from the location 101 of the underwater vehicle at a first time (e.g., t₁), which reflects back to the SSS transducer array from a first region of the seafloor surface 125. The SSS transducer array can subsequently emit additional sonar pulses from the locations 102, 103, 104, 105 as underwater vehicle continues to travel in the along track direction (e.g., left to right in the context of the example diagram 100 of FIG. 1). For example, the SSS transducer array can emit a second sonar pulse from the location 102 of the underwater vehicle at a second time (e.g., t₂), which reflects back to the SSS transducer array from a second region of the seafloor surface 125. The SSS transducer array can emit a third sonar pulse from the location 103 at a third time (e.g., t₃), can emit a fourth sonar pulse from the location 104 at a fourth time (e.g., t₄), can emit a fifth sonar pulse from the location 105 at a fifth time (e.g., t₅), etc.

In a conventional SSS transducer system (e.g., non-SAS), each pulse transmitted by a sonar transducer in the array is used to measure a single, distinct area of the seafloor. The SSS transducer array emits the fan-shaped acoustic pulse, and waits to receive a reflection of the pulse off of the seafloor surface. The conventional SSS transducer array can be configured to wait for each emitted pulse to return before emitting the next pulse (e.g., only after the reflection is received does the SSS transducer array send out another pulse).

In some examples, a synthetic aperture sonar (SAS) system can be configured to emit more frequent and/or overlapping pulses over a period of time as the underwater vehicle (e.g., the underwater vehicle coupled to the SAS transducer array) moves with respect to the seafloor. For example, the sonar pulses emitted at the different locations 151-155 above the seafloor 125 by a SAS transducer are illustrated in the example profile view of the example diagram 150 of FIG. 1. The reflections of the SAS sonar pulses, which cover overlapping areas of the seafloor 125 surface, can be processed to provide an artificial (e.g., synthetic) array that provides increased resolution without changing the physical size of the sonar transducers. For example, a SAS transducer array may be configured to transmit continuous or substantially continuous pulses, and measure reflection returns without processing the obtained data. Instead, the measured reflection return data can later be post-processed to extend the sonar array effective length based on combining the returned signals. Combining the returns from the overlapping sonar pulses can correspond to receiving multiple measurements of a single location (e.g., on or along the seafloor 125 surface) at once, which can be used to thereby increase the resolution of the sonar imagery. In some examples, The collected pulse reflections during the same period of time can later be post-processed and combined into a single SAS return, corresponding to a synthetic array length that can be many multiples of the physical transducer array length. For example, the “synthetic” array length of the combined SAS return from coherently summing the returned waveforms received over the collection period of time can correspond to the along-track distance through which the transducer array is moved during the collection period of time.

In a conventional side-scan sonar, the along-track resolution can correspond to the physical length and/or number of transducers included in the SSS transducer array, with a larger (e.g., longer) array providing increased along-track resolution. Increasing the array length of a side-scan sonar can be challenging, based on greater capital costs for larger SSS transducer arrays, as well as based on physical limitations on the maximum array length supported by the underwater vehicle. In some examples, synthetic aperture sonar (SAS) techniques can be used to increase the spatial resolution of sonar data. For example, SAS techniques can be used for and/or implemented by a side-scan sonar system to increase the along-track resolution without increasing the array length of the SSS transducer array. A conventional SSS transducer array can be configured as an SAS transducer array based on controlling the triggering used to cause the SSS transducer array to emit the fan-shaped sonar pulses. For example, a conventional SSS transducer array may transmit on time (e.g., triggered on time), with a pre-determined time interval between successive pulses. A SAS transducer array (e.g., including a conventional SSS transducer array configured as an SAS) may transmit on distance traveled along the seafloor, with dependencies on the physical array length and the travel speed of the underwater vehicle.

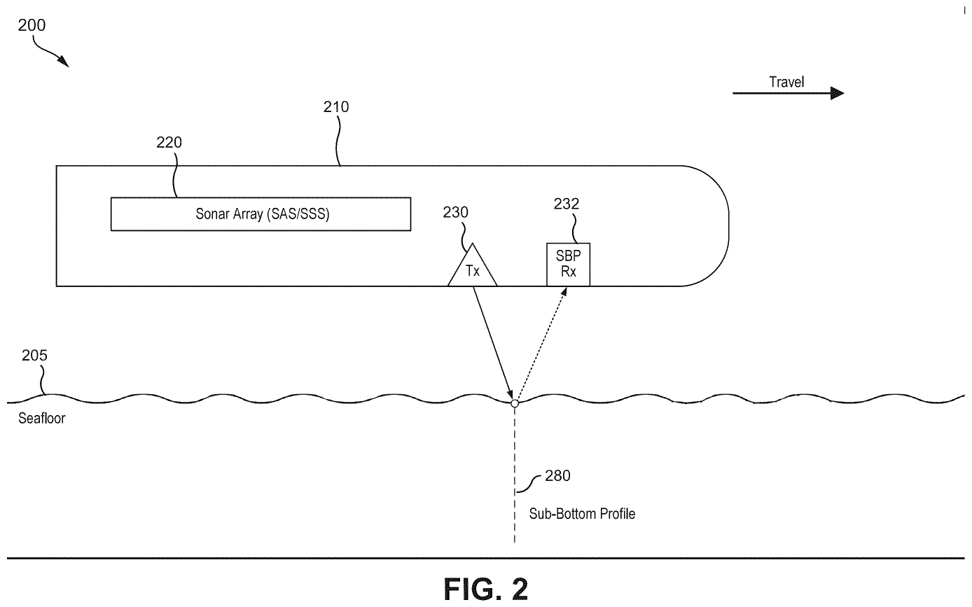

Many marine and underwater surveying operations may combine a first sonar or acoustic system for mapping or imaging the seafloor surface, with a second sonar or acoustic system for mapping a profile of the layers below the seafloor surface (e.g., referred to as the “sub-bottom”). For example, an underwater vehicle may include an SSS or SAS transducer array for mapping the seafloor surface, and may include a sub-bottom profiler (SBP) for mapping the profile of the sub-bottom layers below the seafloor surface. For example, FIG. 2 is a diagram illustrating an example perspective view 200 of an underwater vehicle 210 including a sonar array 220 (e.g., SSS array, SAS array, etc.) and an SBP system including an SBP transmitter 230 and an SBP receiver 232, in accordance with some examples. In some examples, the sonar array 220 can be configured as a side-scan sonar transducer array, and can correspond to the example SSS sonar pulses shown in the example 100 of FIG. 1. In some cases, the sonar array 220 can be a synthetic aperture sonar transducer array, and for example may correspond to the example SAS sonar pulses shown in the example 150 of FIG. 1.

The sub-bottom profiler system (e.g., comprising at least the SBP transmitter 230 and the SBP receiver 232) can be used to perform site characterization and asset integrity marine surveying operations, among various others. For example, sub-bottom profiler sensors can be used to detect and/or identify hazardous conditions on or below the seafloor 205 in the form of targets such as mass transport deposits, faults, gas hydrates, fissures, etc. In some examples, the sub-bottom profiler system can be implemented as a geophysical sensor tool or apparatus that is configured to use sound (e.g., acoustic pulses and corresponding reflections) to map the layers of sediment and rock beneath the seafloor 205. The layers beneath the surface of the seafloor 205 can be referred to as the “sub-bottom” and measurements thereof can be referred to as a “sub-bottom profile,” such as the sub-bottom profile 280 of FIG. 2. In some aspects, the SBP transmitter 230 can be used to emit an acoustic pulse at a downward angle oriented towards the seafloor 205 and sub-bottom layers. The SBP receiver 232 can receive reflections of the pulse that are bounced (e.g., reflected) by the various sub-bottom layers. The reflected energy and/or other information determined based on the pulse reflection information from the SBP receiver 232 can be analyzed and processed to create images of the sub-surface structure beneath the seafloor 205 (e.g., can be analyzed and processed to generate a sub-bottom profile).

In some examples, the SBP transmitter 230 and the SBP receiver 232 can be hull mounted to the underwater vehicle 210, with the SBP transmitter 230 being upstream with respect to the direction of travel of the underwater vehicle 210. The SBP transmitter 230 transmits pulses that travel towards the seabed (e.g., seafloor 205). Sound energy is reflected off the boundaries between layers of different densities, and therefore different acoustic impedance. As a transmitted pulse encounters the boundary between the water and the surface of the seafloor 205, a first portion of the transmitted pulse's energy is reflected (e.g., back to the SBP receiver 232) and a second portion of the transmitted pulse's energy penetrates further into the seabed. As the energy of the transmitted pulse penetrates further (e.g., deeper) into the seabed, additional reflections occur as boundaries between layers of, for example, clay, sand and other sediments are encountered. The SBP receiver 232 can receive the respective reflections of the transmitted pulse as the pulse encounters different layers and/or boundaries within the sub-bottom structure. Accordingly, the reflection information obtained by the SBP receiver 232 for a transmitted pulse from the SBP transmitter 230 can enable an image of the structure beneath the seabed to be built up or otherwise constructed, generated, determined, etc.

In some examples, the distance on the seafloor 205 between the reflection point of successive pulses of the SBP transmitter 230 can control the density of the SBP data collected by the SBP system. This seafloor distance between the successive reflection points can be governed by the pulse repetition rate between successive pulses transmitted by the SBP transmitter 230 and the speed of the underwater vehicle 210. For example, all else held equal, doubling the pulse repetition rate from 0.25 seconds to 0.50 seconds can correspond to doubling the distance along the seafloor 205 between adjacent/successive reflection points corresponding to the SBP transmitter 230 and SBP receiver 232. Likewise, halving the pulse repetition rate from 1.0 seconds to 0.5 seconds can correspond to halving the distance along the seafloor 205 between adjacent/successive reflection points of the SBP transmitter 230 and SBP receiver 232 of the SBP system. In one illustrative example, for a pulse repetition rate of 450 milliseconds (ms) between successive pulses emitted by the SBP transmitter 230, and an underwater vehicle 210 moving at a survey speed of 4 knots (2 m/s), the resulting horizontal distance or displacement between the SBP reflection points can be approximately 0.9 m, etc.

In some cases, the SBP transmitter 230 can be used to transmit acoustic pulses at a pre-determined or configured repetition rate (e.g., a pre-determined or configured period between acoustic pulses), with the transmitted pulses transmitted in a generally downward direction from the underwater vehicle 210 toward the seafloor 205. In some examples, the SBP transmitter 230 can be configured to transmit an acoustic pulse comprising a frequency modulated chirp pulse. A sweep of the pulse can be wideband, for example in the range of 1 kilohertz (kHz) to 10 kHz, although it is noted that various other sweep values and/or frequency ranges may also be utilized without departing from the scope of the disclosure.

In some examples, the underwater vehicle 210 can use the sonar array 220 to perform a sonar survey (e.g., SSS, SAS, etc.) of the seafloor 205. The sonar survey can be performed by the underwater vehicle 210 concurrently, or within the same time window, as the SBP survey of the sub-bottom profiler system comprising the SBP transmitter 230 and SBP receiver 232. Both the sonar transducer array and the SBP system operate based on transmitting one or more acoustic (e.g., sonar) pulses, and measuring the corresponding reflection information of the pulse interacting with the respective target being mapped (e.g., the sonar transducer array 220 measures corresponding reflections from the seafloor 205 surface, while the SBP system uses the SBP receiver 232 to measure reflections from the sub-bottom layers corresponding to the sub-bottom profile 280 below the seafloor 205 surface).

In some examples, the underwater vehicle 210 can be implemented as a sub-surface vehicle that travels within the water column (e.g., below the water surface) during the surveying operations performed by the underwater vehicle 210. For example, to obtain highly accurate and high resolution sub-surface images, an SBP system (e.g., such as the SBP transmitter 230 and SBP receiver 232 of FIG. 2, etc.) can be mounted to an autonomous underwater vehicle (AUV), remote operated vehicle (ROV), etc., to effectively bring the remote sensor(s) of the SBP system closer to the seafloor 205 to retain consistent image quality independent of water depth over an operating range that may extend from between 10 meters to 6,000 meters (or greater).

Interference can occur when transmissions of one system overlap with receptions of the other system. For example, interference can occur if the SBP system transmits a pulse while the SSS or SAS transducer array is receiving reflections of an earlier SSS/SAS pulse. Similarly, interference can occur if the SSS or SAS transducer array transmits pulses while the SBP system is receiving reflections of an earlier SBP pulse. Many SSS systems are configured to transmit on time, and the corresponding reception periods of the SSS transducer array therefore occur during known or pre-determined windows of time. Accordingly, interference between an SSS transducer array and an SBP system can be reduced or avoided by configuring the SBP system to only transmit outside of the pre-determined and periodic reception times of the SSS transducer array.

However, SBP systems are often triggered to transmit on distance, for example to obtain a vertical SBP profile of the sub-bottom seafloor surface every 60 cm (or various other distances, etc.). In some cases, survey-grade AUVs that may be used to implement the SBP system may travel at survey speeds of 1.8 meters per second along the seafloor 205. In some cases, a survey speed of 1.8 meters per second by the underwater vehicle 210 can correspond to a vertical SBP profile being obtained at an interval of every 60 cm of horizontal distance along the seafloor 205 (e.g., based on the SBP transmitter 230 and SBP receiver 232 operating 1.8 m/sec to transmit and receive at approximately 3 Hertz (Hz);

$$\frac{1.8 m / sec}{0.6 m / profile} = 3 profiles / sec ) .$$

The individual SBP profiles are obtained at the respective reflection points for each transmitted pulse, and can correspond to individual SBP measurements (such as the example SBP measurement 280 depicted in the example of FIG. 2) spaced every 60 cm on the seafloor 205 surface. The individual SBP measurements obtained as the vertical SBP profile every 60 cm can be processed and assembled into a single, combined 2-dimensional (2D) digital profile and/or a three-dimensional (3D) seismic cube that can be used for mapping and interpretation of geohazards in the sub-bottom layers beneath the seafloor 205.

In cases where SBP systems are utilized in combination with SSS sonar arrays (e.g., in examples where the sonar array 220 is an SSS sonar array, etc.), the SBP system is often able to achieve the target profiling rate corresponding to the 60 cm profiling interval described above. For example, SSS sonar arrays may be configured to transmit sonar pulses that are triggered on time (e.g., corresponding to a fixed or pre-determined number of sonar pulses per second, with successive sonar pulses separated in time by the SSS sonar array's transmitting rate, etc.). However, for greater survey speeds, the transmitting rate for the SBP system must be increased in time in order to achieve the same spatial resolution or spatial density that corresponds to transmitting an SBP pulse for every fixed distance interval (e.g., every 60 cm, etc.) traveled along the seafloor 205. Accordingly, interference and/or degradation of the SBP spatial density can occur for higher survey speeds, where the SBP transmitting rate would exceed the transmitting/receiving rate of the SSS transducer array.

In another example, the sonar array 220 may be configured as a synthetic aperture sonar. SAS systems are triggered to transmit on distance traveled along the seafloor 205, with the length of the distance trigger primarily a function of the SAS transducer array length (e.g., length of the sonar array 220). In many cases, to avoid acoustic interference with the return signals into the SAS transducer array 220, an SBP system on the same underwater vehicle 210 as the SAS transducer array 220 may be configured to use a lower transmitting rate (e.g., the transmitting rate of the SBP system is lowered to match the transmission of the SAS sonar signal). For higher survey speeds and/or longer SAS array lengths, the maximum SBP transmitting rate when adjusted to be within the SAS transmitting rate may correspond to an SBP spatial density and/or spatial resolution of sub-bottom profile data that is below a targeted or desired value. For example, when the sonar array 220 is a SAS array, and the underwater vehicle is a higher-speed AUV or ROV associated with a survey speed of 4 meters/sec (or greater), the SAS array length of the sonar array 220 may need to be elongated in order to achieve the same sonar range as would be achieved for lower survey speeds of the underwater vehicle 210. Higher survey speeds for a given SAS array length can correspond to a decrease in the sonar range.

In some examples, an AUV with the sonar array 220 implemented as a long array SAS sonar with a length of 1.8 m (e.g., 180 cm) and traveling at a survey speed of 4 m/s may be able to only transmit the SBP system (e.g., transmit an acoustic pulse by the SBP transmitter 230) once per 180 cm of distance traveled along the seafloor 205 in order to avoid interference between the acoustic pulse from the SBP transmitter 230 and the SAS reception by the SAS array 220. The limitation of transmitting the SBP system a maximum of once per 180 cm of distance travelled along the seafloor 205 by the underwater vehicle 210 corresponds to a three times reduction in the along-track spatial density of the SBP measurements, as compared to the 60 cm along-track spatial density of SBP profile measurements that can be obtained with a 3 Hz transmitting and receiving rate of the SBP system when combined with a sonar array 220 that is configured as a conventional side-scan sonar.

In some aspects, the SBP transmitter 230 cannot be used to transmit the SBP acoustic pulse at a distance interval along the seafloor 205 that is less than the array length of the SAS sonar array 220 (e.g., recalling that the SAS sonar systems transmit on distance travelled along the seafloor 205, primarily as a function of the total array length). In other words, transmitting the SBP transmitter 230 at seafloor horizontal distance interval that is shorter than the array length of the SAS sonar 220 can correspond to acoustic interference between the SBP acoustic transmission and the return signals into the SAS array 220 receivers. An SBP acoustic transmission from the SBP transmitter 230 acoustically interfering with the return signals into the SAS sonar array 220 can correspond to a significantly degraded SAS image.

Accordingly, there is thus a need to address at least one of the problems described above by providing a solution for performing SBP surveying operations and additional sonar surveying operations (e.g., SAS, SSS, etc.) by an underwater vehicle that includes both an SBP and an additional sonar transducer system, such as an SSS-based sonar and/or an SAS-based sonar transducer system.

The systems and techniques described herein can be used to provide a multi-channel sub-bottom profiler (SBP) acquisition system with orientation and/or motion compensation for each SBP channel of the multiple SBP channels. The multiple SBP channels can correspond to multiple SBP receivers configured to receive reflected acoustic pulses transmitted by an SBP transmitter. For example, each SBP channel of the multiple SBP channels can correspond to a respective SBP receiver of the multiple SBP receivers. In some cases, orientation and/or motion compensation can be applied during post-processing performing for the SBP reflection data measured by each SBP receiver on the corresponding SBP channel. For example, the orientation and/or motion compensation be implemented based on the particular location of each SBP receiver on the underwater vehicle, and measured sensor information corresponding to the motion and/or orientation of the underwater vehicle at the time of the SBP data acquisition. The motion and/or orientation sensor data used for the post-processing multi-channel SBP compensation can include roll, pitch, yaw, and/or other inertial or kinematic information corresponding to the underwater vehicle and multi-channel SBP system including the multiple SBP receivers. In some cases, the post-processing multi-channel SBP orientation and/or motion compensation can be performed based on sensor data obtained from an inertial navigation system (INS) associated with the underwater vehicle or otherwise rigidly coupled to the multi-channel SBP system.

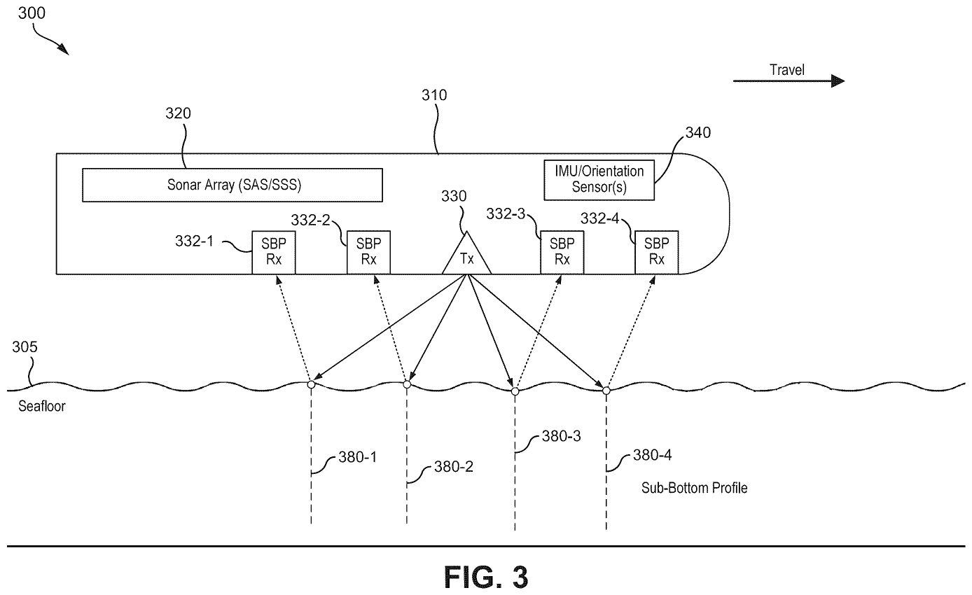

For example, FIG. 3 is a diagram illustrating an example perspective view 300 of an underwater vehicle 310 including a sonar array 320 (e.g., SSS array, SAS array, etc.) and a multi-channel SBP system including an SBP transmitter 330 and a plurality of SBP receivers 332-1, 332-2, 332-3, 332-4 arranged according to a first configuration of the multi-channel SBP system, in accordance with some examples. In some aspects, the underwater vehicle 310 may be the same as or similar to the underwater vehicle 210 of FIG. 2. For example, the underwater vehicle 310 can be implemented as a surface or sub-surface vessel, including an AUV, ROV, UUV, etc. configured to perform combined SAS/SSS sonar surveying operations using the sonar array 320 and SBP surveying operations using the SBP system including the SBP transmitter 330 and SBP receivers 332-1, 332-2, 332-3, 332-4. In some examples, the sonar array 320 of FIG. 3 can be the same as or similar to the sonar array 220 of FIG. 2. In some embodiments, the SBP transmitter 330 of FIG. 3 can be the same as or similar to the SBP transmitter 230 of FIG. 2. In some cases, the SBP receivers 332-1, 332-2, 332-3, 332-4 can be the same as or similar to one another, and may be distributed on or parallel to an along-track axis of the underwater vehicle 310, where the along-track axis corresponds to the direction of travel of the underwater vehicle 310 (e.g., shown in FIG. 3 as the direction from left to right). In some cases, the SBP receivers 332-1, 332-2, 332-3, 332-4 can be the same as or similar to the SBP receiver 232 of FIG. 2.

The underwater vehicle 310 can include one or more inertial and/or orientation sensors 340, that can be used to obtain and/or measure inertial sensor data corresponding to one or more movements of the underwater vehicle 310. The one or more inertial and/or orientation sensors 340 can include one or more inertial measurement units (IMUs), gyroscopes, accelerometers, etc. In some aspects, the inertial and/or orientation sensors 340 can be included within an inertial navigation system (INS) of the underwater vehicle 310. In some cases, the inertial and/or orientation sensors 340 of FIG. 3 can be the same as an INS of the underwater vehicle 310. The underwater vehicle 310 can be used to perform surveying operations using the sonar array 320 and SBP system, while the underwater vehicle 310 travels above the seafloor 305 surface. In some aspects, the seafloor 305 of FIG. 3 can be the same as or similar to the seafloor 205 of FIG. 2 and described previously above.

The SBP system can be implemented as a multi-channel SBP system (e.g., a multi-receiver SBP system) that includes one or more SBP transmitters (e.g., where the one or more SBP transmitters includes at least the SBP transmitter 330), and a plurality of SBP receivers configured to measure respective reflections of an acoustic pulse transmitted by the one or more SBP transmitters. The SBP system can implement a transmit once, measure multiple times paradigm, wherein each SBP receiver of the plurality of SBP receivers 332-1, 332-2, 332-3, 332-4 is configured to measure a respective reflection of the same transmitted pulse from the SBP transmitter 330. In the example configuration shown in FIG. 3, one transmission of an acoustic pulse by the SBP transmitter 330 can correspond to four different SBP profile measurements being obtained by the four respective SBP receivers 332-1, 332-2, 332-3, and 332-4.

For example, each measurement cycle of the SBP system can correspond to one transmission of an acoustic pulse by the SBP transmitter 330, and the subsequent reception of reflection(s) of the transmitted pulse by each of the four SBP receivers 332-1, 332-2, 332-3, and 332-4. The measurement cycle of the SBP system can start at the time the SBP transmitter 330 transmits a first acoustic pulse, and can end at a later time when the SBP receivers 332-1, 332-2, 332-3, 332-4 have completed measurement of the reflections of the pulse, and/or can end at a later time that is immediately before the time when the SBP transmitter 330 transmits a next, second acoustic pulse for a second measurement cycle. In some embodiments, each measurement cycle of the SBP system can correspond to SBP acoustic measurement data that is obtained using each respective receiver of the plurality of SBP receivers 332-1, 332-2, 332-3, 332-4 included in the multi-channel SBP system shown in FIG. 3.

For example, in some cases, the acoustic measurement data for one measurement cycle of the SBP system and SBP transmitter 330 can include measurements of the respective first SBP data 380-1, obtained by the first SBP receiver 332-1 based on a first reflection of the transmitted pulse from the SBP transmitter 330 (e.g., corresponding to a first location on the seafloor 305, where the transmitted pulse from SBP transmitter 330 reflects upward to be received by the first SBP receiver 332-1); can include measurements of the respective second SBP data 380-2, obtained by the second SBP receiver 332-2 based on a second reflection of the transmitted pulse from the SBP transmitter 330 (e.g., corresponding to a second location on the seafloor 305, where the transmitted pulse from SBP transmitter 330 reflects upward to be received by the second SBP receiver 332-2); can include measurements of the respective third SBP data 380-3, obtained by the third SBP receiver 332-3 based on a third reflection of the transmitted pulse from the SBP transmitter 330 (e.g., corresponding to a third location on the seafloor 305, where the transmitted pulse from SBP transmitter 330 reflects upward to be received by the third SBP receiver 332-3); and can include measurements of the respective fourth SBP data 380-4, obtained by the fourth SBP receiver 332-4 based on a fourth reflection of the transmitted pulse from the SBP transmitter 330 (e.g., corresponding to a fourth location on the seafloor 305, where the transmitted pulse from SBP transmitter 330 reflects upward to be received by the fourth SBP receiver 332-4).

In some embodiments, the multi-channel and multi-receiver SBP system comprising the SBP transmitter 330 and the plurality of SBP receivers 332-1, 332-2, 332-3, 332-4 can be rigidly mounted to the underwater vehicle 310 (e.g., unlike in conventional seismic streamer systems, which are deployed on a non-rigid tether or line towed behind a surface vessel, and remain at or near the surface of the water). In some aspects, the multi-channel and multi-receiver SBP system can be used to collect SBP measurement data within close proximity to the seafloor 305 surface, for example within distances of less than approximately 50 meters from the seafloor 305, in water depths of up to, or exceeding, 6,000 meters, while maintaining a tight beam footprint and high resolution.

Based on the rigid attachment of the SBP system to the underwater vehicle 310, the INS, IMU, inertial, and/or orientation data obtained from the sensors 340 and corresponding to movements of the underwater vehicle 310 can be projected to the respective locations of each respective SBP receiver of the plurality of SBP receivers 332-1, 332-2, 332-3, 332-4. In particular, the IMU/orientation sensors 340 can be used to correct for roll, pitch, yaw, and depth to compensate for three-dimensional movements of the underwater vehicle 310 during acquisition by the multi-channel and multi-receiver SBP system. For example, based on time synchronization between the IMU/orientation sensors 340 and the respective SBP receivers 332-1, 332-2, 332-3, 332-4, the inertial/orientation sensor data can be used for post processing of the multi-channel and multi-receiver SBP data. Based on the location of the IMU/orientations sensors 340 and the location of each SBP receiver (and the SBP transmitter 330, for motion correction of the SBP transmitter during a measurement cycle), the respective measurements obtained during a given measurement cycle by each SBP receiver can be normalized to the same normalized horizontal plane, thereby canceling out and compensating any roll, pitch, yaw, and/or depth-induced artifacts or errors that may be present within the SBP measurement data prior to the motion correction post-processing.

In some examples, the roll, pitch, yaw, and depth corrections can be applied independently for each channel of the multi-channel SBP system, where each individual channel corresponds to the measurement data obtained by a different respective SBP receiver of the plurality of SBP receivers 332-1, 332-2, 332-3, 332-4. For example, a first channel of the SBP system can correspond to measurement data from the first SBP receiver 332-1, a second channel of the SBP system can correspond to measurement data from the se3cond SBP receiver 332-2, a third channel of the SBP system can correspond to measurement data from the third SBP receiver 332-3, a fourth channel of the SBP system can correspond to measurement data from the fourth SBP receiver, etc.

In one illustrative example, the roll, pitch, yaw, and depth corrections can be applied independently for each channel of the multi-channel SBP system, based on projecting the inertial data from the IMU/orientation sensors/INS 340 location on the underwater vehicle 310, to the respective location of each SBP receiver or transmitter on the underwater vehicle 310. In some embodiments, the roll, pitch, yaw, and depth corrections can be implemented using up to a 100 Hz update rate of the INS or other IMU/orientation sensors 340 of the underwater vehicle 310. Greater or lesser update rates can also be utilized without departing from the scope of the present disclosure. In some cases, the roll, pitch, yaw, and/or depth corrections based on the inertial data of the underwater vehicle 310 can be used to implement motion compensation, orientation compensation, roll compensation, pitch compensation, yaw compensation, depth compensation, etc., to normalize the respective SBP measurement obtained by each SBP receiver in a given measurement cycle to a same, normalized horizontal plane. In other words, each measurement cycle can be associated with a calculated, normalized horizontal plane to which the respective SBP measurements from each SBP receiver is normalized to be within.

In one illustrative example, a pitch up motion of the underwater vehicle 310 during a measurement cycle of the SBP system can cause the two front SBP receivers 332-3 and 332-4 to obtain their respective SBP measurements from a height above the seafloor 305 that is greater than the height of the normalized horizontal plane. The SBP receiver 332-4 can have the largest vertical displacement upward and away from the normalized horizontal plane, and the SBP receiver 332-3 can have the second largest vertical displacement upward and away from the normalized horizontal plane (e.g., based on the two front SBP receivers 332-3 and 332-4 being forward of the pitch axis of the underwater vehicle 310). The same pitch-up motion of the underwater vehicle 310 during the measurement cycle of the SBP system can cause the two rear SBP receivers 332-1 and 332-2 to be displaced vertically downward, away from the height of the normalized horizontal plane, such that the two rear SBP receivers 332-1 and 332-2 measure the reflections of the transmitted acoustic pulse from the SBP transmitter 330 at a shorter distance from the seafloor 305 than if the underwater vehicle 310 had been perfectly level during the measurement cycle. The rear-most SBP receiver 332-1 can experience the largest downward displacement from the height of normalized horizontal plane, and the SBP receiver 332-2 can experience the second largest downward displacement from the height of the normalized horizontal plane. In examples where the multiple SBP receivers 332-1, 332-2, 332-3, 332-4 are symmetric about the pitch axis or center-of-pitch for the underwater vehicle 310, the upward vertical displacement of the SBP receiver 332-4 during a pitch-up motion of the underwater vehicle 310 can have the approximately same magnitude as the downward vertical displacement of the SBP receiver 332-1 during the pitch-up motion of the underwater vehicle 310. If the SBP receivers are not arranged symmetrically about the pitch axis or center-of-pitch of the underwater vehicle 310, the magnitude of displacement for each respective receiver from the normalized horizontal measurement plane can be different for each receiver.

In some aspects, one or more (or both) of the sonar array 320 and the SBP system (e.g., the SBP transmitter 330 and the plurality of SBP receivers 332-01, 332-2, 332-3, 332-4) of FIG. 3 can be mounted and/or rigidly attached or affixed to a hull or exterior surface of the underwater vehicle 310. In some aspects, the SBP system can comprise a rigid frame to which the SBP transmitter 330 and the plurality of SBP receivers 332-01, 332-2, 332-3, 332-4 are attached, and where the rigid frame can be used to mount the SBP system to the underwater vehicle 310. In some aspects, the SBP transmitter 330 and the plurality of SBP receivers 332-01, 332-2, 332-3, 332-4 are positioned on the frame such that they sit on a single axis of the frame, with the SBP transmitter 330 being disposed between the SBP receivers 332-1, 332-2 to the rear and the SBP receivers 332-3, 332-4 to the front. The SBP transmitter 330 and the plurality of SBP receivers may be spaced apart by a predetermined separation. In some aspects, the separation between SBP receivers 332-1 and 332-2 can be the same as the separation between SBP receiver 332-2 and the SBP transmitter 330, which can be the same as the separation between the SBP transmitter 330 and the SBP receiver 332-3, etc. In some embodiments, the separation between the SBP transmitter 330 and one or more (or both) of the SBP receivers 332-2 and/or 332-3 can be different from (e.g., larger or smaller than) the inter-SPB receiver separation distance between SBP receiver 332-1 and 332-2, and/or between SBP receiver 332-3 and 332-4, etc. In some embodiments, the frame of the multi-channel and multi-receiver SBP system can be mounted to the hull or other exterior surface of the underwater vehicle 310 such that the above-mentioned axis is in alignment with the direction of travel of the underwater vehicle 310 (e.g., the along-track axis or direction of the underwater vehicle 310, which corresponds to the direction of travel of the underwater vehicle 310 during the surveying operations, shown in the example of FIG. 3 as the survey direction from left to right).

In some cases, the SBP receivers 332-1, 332-2, 332-3, 332-4 can comprise hydrophones. Rather than disposing the hydrophones within an oil or solid towed streamer, e.g., as in conventional seismic streamer techniques, the SBP receivers 332-1, 332-2, 332-3, 332-4 can be implemented as flat-panel SBP receiver hydrophones mounted directly to a host AUV/ROV body (e.g., a body, hull, outer surface, etc., of the underwater vehicle 310) in the open sea water above the seafloor 305. In some embodiments, the SBP receiver hydrophones may be implemented with a round body or housing, corresponding to omnidirectional hydrophone receiving characteristics of the reflected acoustic pulse(s) from the SBP transmitter 330. In one illustrative example, the SBP receivers 332-1,m 332-2, 332-3, 332-4 can be implemented as relatively large, planar hydrophones, for instance using a relatively large PVDF panel between 1,000-10,000 cm² in surface area. However, it is noted that various other planar hydrophone constructions and designs can also be utilized, including with materials other than PVDF and/or sizes larger or smaller than the 1,000-10,000 cm² surface area range in the example above. In some examples, the SBP receivers 332-1, 332-2, 332-3, 332-4 can be implemented as flat/planar PVDF panels that are flexible, flat, and directed at the seafloor 305 surface for improved, enhanced, maximized, optimized, etc., signal recovery of the reflection(s) of the transmitted acoustic pulses from the SBP transmitter 330 and reflecting off the boundary layers within the sub-bottom profile layers below the seafloor 305 surface.

The SBP receivers 332-1, 332-2, 332-3, 332-4 can be implemented as independent receivers mounted to the exterior surface of the underwater vehicle 310. In some aspects, the SBP receivers 332-1, 332-2, 332-3, 332-4 can be implemented as a multi-channel, multi-receiver array of independent receiver hydrophones. In one illustrative example, the configuration of the multiple SBP receivers is oriented along the along-track dimension or axis of the underwater vehicle (e.g., left to right in the example of FIG. 3), to thereby increase the along-track spatial density of the SBP profile(s) obtained using the presently disclosed multi-channel SBP systems and techniques. In some embodiments, the SBP system of FIG. 3 can be configured to collect sub-bottom profile measurement data from altitudes above the seafloor 305 between 5 m to 100 m or greater. In some aspects, the SBP transmitter 330 and the plurality of SBP receivers 332-1, 332-2, 332-3, 332-4 can be configured to transmit and receive with a designed penetration depth below the seafloor 305 surface to depths up to or in excess of 200 meters. In some examples, the penetration depth of the SBP system of FIG. 3 can be configured to be approximately the same as the lateral range used by the sonar array 320. For example, the sonar array 320 can be an SAS sonar array with a lateral range or swath width of 200-250 meters, and the SBP system of FIG. 3 can be implemented to measure SBP profile information to a penetration depth of approximately 200-250 meters below the surface of the seafloor 305, etc.

In one illustrative example, the SBP transmitter(s) 330 of the multi-channel, multi-receiver SBP system of FIG. 3 can be configured to use a trigger signal associated with a synthetic aperture sonar (SAS) (e.g., the sonar array 320, etc.). In some aspects, the transmission of a sonar pulse by the SAS sonar array 320 can be used to automatically trigger or cause the SBP transmitter 330 to transmit the acoustic pulse for the SBP measurements by the plurality of SBP receivers 332-1, 332-2, 332-03, 332-4 disposed on the along-track axis of the underwater vehicle 310. For example, the transmitter(s) of the SAS sonar array 320 can be configured or implemented as a primary trigger for the combined SAS-SBP system of FIG. 3. The transmitter(s) of the SAS sonar array 320 trigger based on distance traveled by the underwater vehicle 310 along the seafloor 310, and the transmitter(s) of the SAS sonar array 320 can therefore be triggered to transmit a sonar pulse at each trigger point of a plurality of trigger points spaced at an equal horizontal displacement along the seafloor 305 (e.g., faster survey speeds of the underwater vehicle 310 correspond to the SAS sonar array 320 triggering the sonar pulse transmission more rapidly in time, in order to achieve the same horizontal distance between transmission cycles along the seafloor 305, when traveling at the higher survey speeds). When the SAS sonar array 320 determines a corresponding one of the SAS trigger points (distance-based trigger points or locations on the seafloor 305, etc.) has been reached, the SAS sonar array 320 will fire the sonar pulse transmitter. Firing the SAS sonar array 320 can be configured to automatically output a triggering signal to the sub-bottom profiler system. In particular, firing the SAS sonar array 320 can automatically output a triggering signal to the SBP transmitter 330, to cause the SBP transmitter 330 to fire and transmit a single acoustic pulse corresponding to one measurement cycle of the SBP system. In this manner, the transmission/measurement cycle of the SAS sonar array 320 can trigger, and can include, the transmission/measurement cycle of the multi-channel, multi-receiver SBP system. The duration of the transmission/measurement cycle of the multi-channel, multi-receiver SBP system can be within (e.g., less than or equal to) the duration of the transmission/measurement cycle of the SAS sonar array 320. In some embodiments, the triggering signal automatically output in response to the SAS sonar array 320 firing a sonar pulse can be a trigger signal output as a dig and/or output on a physical trigger line (e.g., TTL) communicatively coupled or connected between the SAS sonar array 320 and the SBP transmitter 330.

The SAS sonar array 320 can be configured to fire (e.g., cause a transmitter or transducer of the SAS sonar array 320 to transmit/emit a sonar pulse) according to a first transmission rate. The first transmission rate can correspond to a configured distance along the seafloor 305 surface. For example, the sonar pulse can be a sonar pulse that is transmitted based on a distance traveled along the seafloor 305 surface by the underwater vehicle 310. In some cases, the sonar pulse can be transmitted by a transmitter included in the sonar transducer array 320. In some embodiments, the sonar pulse transmitted using the sonar transducer array can correspond to one of the sonar pulses 101-105 shown in the example diagram 100 corresponding to SSS sonar transmissions illustrated in FIG. 1. In some examples, the sonar pulse transmitted using the sonar transducer array can correspond to one of the sonar pulses 151-155 shown in the example diagram 150 corresponding to SAS sonar transmissions illustrated in FIG. 1. In some aspects, the SAS sonar array 320 can be configured to fire according to a first transmission rate, where the first transmission rate corresponds to a distance along the seafloor 305 that is based on the array length of the SAS sonar array 320. For example, the distance corresponding to the first transmission rate can be equal to the array length of the SAS sonar array 320, and/or can be a multiple of the array length of the SAS sonar array 320. For instance, the SAS sonar array 320 may have an array length of 1.8 m and the first transmission rate can correspond to firing the SAS sonar array 320 to transmit a sonar pulse every 1.8 m of distance traveled along the seafloor 305 surface, where greater survey speeds of the underwater vehicle 310 correspond to a higher value of the first transmission rate (e.g., firing an increased number of times per second, based on a higher survey speed causing the underwater vehicle 310 to pass through a greater quantity of 1.8 m intervals of distance along the seafloor 305 each second, etc.).

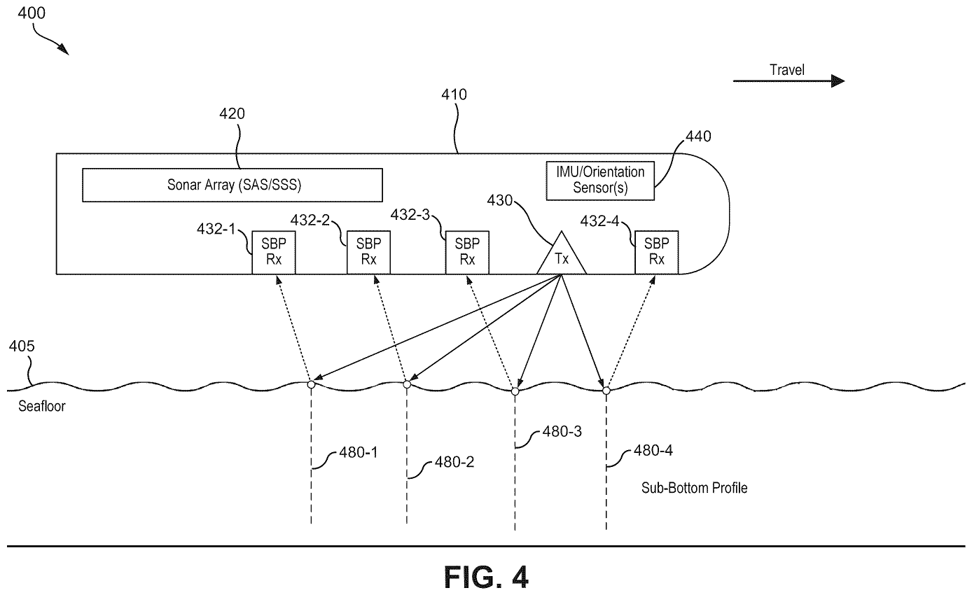

In some embodiments, the systems and techniques described herein for the multi-channel, multi-receiver SBP system (e.g., such as the SBP system of FIG. 3, corresponding to the SBP transmitter 330 and the plurality of SBP receivers 332-1, 332-2, 332-3, 332-4; and/or the SBP system of FIG. 4, corresponding to the SBP transmitter 430 and the plurality of SBP receivers 432-1, 432-2, 432-3, 432-4; etc.) can be used to increase the along-track spatial density of SBP profile measurements obtained by an underwater vehicle performing concurrent SAS sonar surveys and SBP surveys. The SBP transmitter may be configured to transmit acoustic pulses at a transmission/measurement cycle duration that is limited to be within the transmission/measurement cycle of the SAS sonar array 320. In such cases, the spatial density of the transmission of acoustic pulses by the SBP transmitter 330 can be equal to the spatial density of the transmission of sonar pulses by the SAS sonar array 320, and can correspond to a distance traveled along the seafloor 305 that is equal to the array length (or a multiple thereof) of the SAS sonar array 320. The multi-channel, multi-receiver configuration of the SBP system can be used to increase the spatial density of the SBP profile measurements by a factor equal to the quantity of SBP receivers included in the multi-receiver SBP system. For instance, the four SBP receivers of the multi-channel, multi-receiver SBP systems of FIG. 3 and FIG. 4 can increase the spatial density of the resulting SBP profile measurements by a factor of four. In one illustrative example, the SAS sonar array 320 can have a length of 1.8 m, and the SAS sonar array 320 can be fired every 1.8 m. The SBP transmitter 330 can be triggered off of the SAS sonar array 320 firing, and can likewise be fired approximately every 1.8 m, resulting in a spatial density of SBP transmission of one SBP acoustic pulse per 1.8 m along the seafloor 305. The four SBP receivers 332-1, 332-2, 332-3, 332-4 can increase the spatial density in the along-track direction to one SBP profile measurement every 1.8 m/4=0.45 m=45 cm.

To obtain the SBP profile measurements 3801-1, 380-2, 380-3, 380-4 with an improved (e.g., increased) spatial density, the SBP transmitter(s) 330 produces sonar waves in response to being triggered to emit an acoustic pulse in response to the SAS sonar array 320 firing (e.g., in response to the SAS sonar array 320 transmitting a sonar pulse, the SBP transmitter(s) 330 are triggered to transmit an acoustic pulse). Subsequently, the SAS sonar array 320 receivers listen for reflections of the transmitted sonar pulse, and the SBP receivers 332-1, 332-2, 332-3, 332-4 listen for reflections of the transmitted acoustic pulse. The multiple SBP receivers convert the reflected waves into electrical signals, with the measurement data (e.g., electrical signals) measured by each respective one of the plurality of SBP receivers 332-1, 332-2, 332-3, 332-4 being recorded on an individual channel of a corresponding plurality of channels implemented by the multi-channel, multi-receiver SBP system of FIG. 3. Each channel corresponds to a different SBP receiver at a different location on the along-track axis of the underwater vehicle 310. Each channel can be recorded individually to obtain the respective acoustic measurement data of the reflected pulse recorded at each individual SBP receiver 332-1, 332-2, 332-3, 332-4. Each channel's acoustic measurement data can be stored with time stamp information to support later post-processing operations to perform independent and motion correction on each channel, to compensate for three-dimensional pitch, roll, and/or yaw of the underwater vehicle 310 during respective measurement cycles of a plurality of measurement cycles performed by the multi-channel, multi-receiver SBP system (e.g., where each measurement cycle of the SBP system corresponds to transmission of one acoustic pulse by the SBP transmitter 330 and the subsequent measurement of reflections of the transmitted acoustic pulse by each receiver of the plurality of SBP receivers 332-1, 332-2, 332-3, 332-4).

In some embodiments, the post-processing of the multi-channel, multi-receiver SBP measurement data can include processing using seismic methods to normalize the signals before combining them into a continuous digital SBP profile with a spatial density in the along-track direction that corresponds to the number of SBP receivers included in the plurality of SBP receivers implemented by the multi-channel, multi-receiver SBP system. The post-processing can be implemented according to multi-channel seismic processing and/or post-processing techniques, adjusted based on the configuration where the multi-channel, multi-receiver SBP system of FIG. 3/FIG. 4 is rigidly mounted to the AUV host body (e.g., hull, body, or other exterior surface of the underwater vehicle 310, etc.) for operation in water depths from 10 to 6,000 meters or deeper. In the post-processing operations performed to generate a continuous SBP profile with spatial density corresponding to the along-track configuration of the multiple SBP receivers 332-1, 332-2, 332-3, 332-4, each channel is motion compensated for roll, pitch, yaw, and depth in 3-dimensional space via an onboard inertial navigation system (e.g., the onboard INS including or implementing the IMU/orientation sensors 340 of FIG. 3, etc.).

For example, the underwater vehicle 310 (e.g., AUV, ROV, ROTV, UUV, etc.) may typically pitch up to ±30 degrees during normal surveying operations in dynamic seabed terrain (e.g., above the seafloor 305, etc.), due to a terrain-following mode implemented by many AUVs to maintain an approximately constant height or altitude above the seafloor 305 at each instantaneous location of the AUV above the terrain of the seafloor 305, etc.). Each SBP receiver 332-1, 332-2, 332-3, 332-4 can accordingly be corrected in three-dimensional space relative to the transmitter 330 of the multi-channel, multi-receiver SBP system, and/or relative to a normalized horizontal plane determined for performing compensation of each channel/SBP receiver within a given measurement cycle corresponding to an acoustic pulse transmitted by the SBP transmitter 330. The correction and/or normalization post-processing operations can correct each receiver's location in 3D space to lay on or within the normalized horizontal plane. After normalizing the vertical location of each receiver, the corresponding measurement data on teach receiver's SBP channel can then be combined into one continuous profile per survey line of the underwater vehicle 310.

With multiple receivers implemented in the SBP system of FIG. 3 and/or FIG. 4, additional seismic-based techniques can be applied to further improve the SBP profile data quality, vertical resolution, and/or penetration. For example, the multiple SBP receivers can enable post-processing operations to generate a continuous, normalized SBP profile data with increased spatial measurement density beyond the spatial transmission density of the acoustic pulses emitted by the SBP transmitter 330. In some aspects, the multiple SBP receivers can enable post-processing operations to generate a continuous, normalized SBP profile data using one or more of demultiplexing processing operations, edit processing operations, geometry processing operations, anti-aliasing and/or other filtering processing operations, gain recovery processing operations, deconvolution processing operations, statics processing operations, de-multiple processing operations, f-k or apparent velocity filter processing operations, normal moveout (NMO) correction processing operations, dip moveout (DMO) processing operations, common midpoint (CMP) stack processing operations, post-stack filter processing operations, and/or post-stack mix processing operations, among various others.

In some aspects, with the underwater vehicle 310 (e.g., AUV) continuing to travel through the water at the survey speed after the SBP transmitter 330 is fired, the SBP receivers 332-1, 332-2, 332-3, 332-4 will also continue to move through the water after the SBP transmitter 330 is fired. This movement based on the underwater vehicle 310 survey speed can introduce time-variant positioning errors in the recorded SBP measurement data, which can cause horizontal smearing of the measured SBP profile data. In some embodiments, receiver motion compensation (RMC) post-processing can be performed based on the inertial and/or orientation sensors data from the sensors 340 and/or INS of the underwater vehicle 310. The RMC post-processing techniques can be used to remove the horizontal smearing errors from the recorded SBP profile data, and to place the data in the position that would have been recorded by each respective SBP receiver of the multiple SBP receivers 332-1, 332-2, 332-3, 332-4 had the receivers remained stationary for the duration of the recording (e.g., remained stationary for the duration of the transmission/measurement cycle of the multi-channel, multi-receiver SBP system of FIG. 3, etc.). The RMC post-processing can be implemented as a two-dimensional (2D) spatial correction process, with the 2D spatial correction applied to the measurement data recorded onto the corresponding SBP channel (of the multiple SBP channels) by each respective SBP receiver of the multiple SBP receivers 332-1, 332-2, 332-3, 332-4. The 2D spatial correction can be applied to the measurement data of each respective SBP receiver based on the sample interval of the multi-channel, multi-receiver SBP system, the receiver spacing (e.g., along-track distance separating adjacent pairs of SBP receivers, such as between SBP receivers 332-1, 332-2; between SBP receivers 332-3, 332-3; between SBP receivers 332-3, 332-4; etc.), and the sample rate. The 2D spatial correction can shift data horizontally toward the front of the linear array of multiple SBP receivers and the SBP transmitter that are arranged in the linear configuration along the along-track axis of the underwater vehicle 310. In some examples, the amount or magnitude of the 2D spatial correction for RMC can increase with recording time and the survey speed at which the AUV or underwater vehicle 310 is traveling during the one or more measurement cycles of the multi-channel, multi-receiver SBP system for which the correction is being applied.

In some aspects, the example of FIG. 3 corresponds to a first configuration of the multi-channel, multi-receiver SBP system, where the plurality of SBP receivers 332-1, 332-2, 332-3, 332-4 are disposed in a linear configuration that is symmetric about the SBP transmitter 330 located at the center of the linear array of the plurality of SBP receivers. In some embodiments, a second configuration of the multi-channel, multi-receiver SBP system can correspond to the linear configuration of the SBP system of FIG. 4, where a greater quantity of SBP receivers are located behind the SBP transmitter 430 than the lesser quantity of SBNP receivers located ahead of the SBP transmitter 430, in the second linear configuration of the multi-channel, multi-receiver SBP system of FIG. 4 that is also aligned along the along-track axis of the underwater vehicle 410. For example, FIG. 4 is a diagram illustrating an example perspective view 400 of an underwater vehicle 410 including a sonar array 420 (e.g., SSS array, SAS array, etc.) and a multi-channel SBP system including an SBP transmitter 430 and a plurality of SBP receivers 432-1, 432-2, 432-3, 432-4 arranged according to a second configuration of the multi-channel SBP system, in accordance with some examples.

In some aspects, the underwater vehicle 410 of FIG. 4 can be the same as or similar to the underwater vehicle 310 of FIG. 3. The sonar array 420 of FIG. 4 can be an SAS or SSS sonar array, and may be the same as or similar to the sonar array 320 of FIG. 3. The IMU/orientation sensors 440 of FIG. 4 can be the same as or similar to the IMU/orientation sensors 340 of FIG. 3. The SBP transmitter 430 of FIG. 4 can be the same as or similar to the SBP transmitter 330 of FIG. 3. The four SBP receivers 432-1, 432-2, 432-3, 432-4 of FIG. 4 can be the same as or similar to the respective four SBP receivers 332-1, 332-2, 332-3, 332-4 of FIG. 3. The seafloor 405 of FIG. 4 can be the same as or similar to the seafloor 305 of FIG. 3. The respective sub-bottom profile measurement locations 480-1, 480-2, 480-3, 480-4 of FIG. 4 can be the same as or similar to the respective sub-bottom profile measurement locations 380-1, 380-2, 380-3, 380-4 of FIG. 3.

In the first linear configuration of the multi-receiver SBP system of FIG. 3, the plurality of receivers 332-1, 332-2, 332-3, 332-4 of the SBP system and the transmitter 330 of the SBP system are arranged in the linear configuration oriented along an along-track axis of the underwater vehicle 310. For example, the linear configuration can correspond to the first configuration of the SBP system transmitter 330 and plurality of SBP receivers 332-1, 332-2, 332-3, 332-4 shown in FIG. 3, where the SBP transmitter 330 is disposed between the pair of SBP receivers 332-1, 332-2 to the rear and the pair of SBP receivers 332-3, 332-4 toward the front in the direction of travel of the underwater vehicle 310. In some examples, the linear configuration can correspond to the second configuration of the SBP system transmitter 430 and the plurality of SBP receivers 432-1, 432-2, 432-3, 432-4 shown in the example of FIG. 4, where the SBP transmitter 430 is disposed between the three SBP receivers 432-1, 432-2, 432-3 toward the rear of the underwater vehicle 410, and the fourth SBP receivers 432-4 toward the front of the underwater vehicle 410, in the direction of the travel of the underwater vehicle 410.

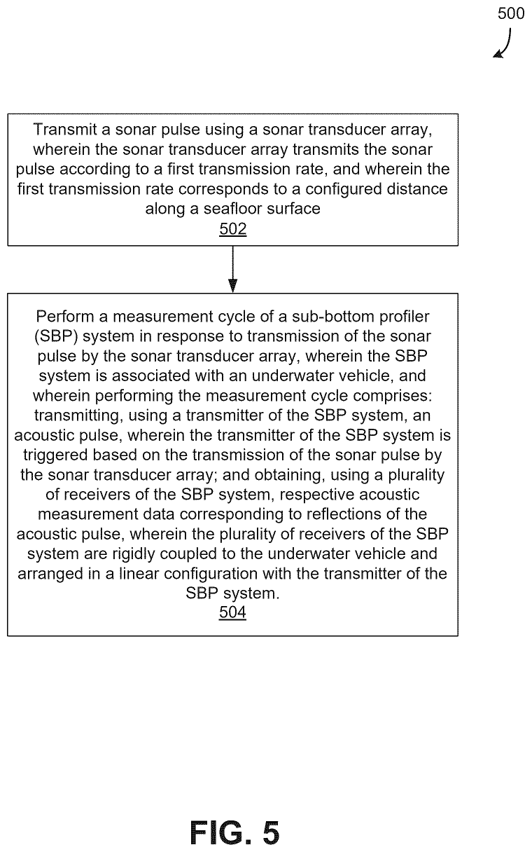

FIG. 5 is a flowchart diagram illustrating an example of a process 500 for marine surveying. For example, the process 500 can correspond to underwater sensing and/or acoustic surveying acquisition systems and methods of use thereof, such as an orientation and/or motion compensated multi-channel sub-bottom profiler (SBP) including one or more transmitters and a plurality of receivers arranged in an along track direction, where the SBP transmitter(s) can be configured to use a trigger signal associated with a synthetic aperture sonar (SAS) included in a same underwater vehicle as the multi-channel SBP. In some aspects, at block 502, the process 500 can include transmitting a sonar pulse using a sonar transducer array, wherein the sonar transducer array transmits the sonar pulse according to a first transmission rate, and wherein the first transmission rate corresponds to a configured distance along a seafloor surface. For example, the sonar pulse can be a sonar pulse that is transmitted based on a distance traveled along the seafloor surface by the underwater vehicle. In some cases, the sonar pulse can be transmitted by a transmitter included in the sonar transducer array. The sonar transducer array can be a side-scan sonar (SSS) transducer array, a synthetic aperture sonar (SAS) transducer array, an SSS transducer array configured for SAS operations, etc., among various other active acoustic sensor arrays and/or echosounders that operate based on transmitting sound and analyzing a resultant reflected signal from a target or area. In some embodiments, the sonar pulse transmitted using the sonar transducer array can correspond to one of the sonar pulses 101-105 shown in the example diagram 100 corresponding to SSS sonar transmissions illustrated in FIG. 1. In some examples, the sonar pulse transmitted using the sonar transducer array can correspond to one of the sonar pulses 151-155 shown in the example diagram 150 corresponding to SAS sonar transmissions illustrated in FIG. 1. In some examples, the sonar transducer array can be the same as or similar to one or more of the sonar array 220 of FIGS. 2, 320 of FIGS. 3, 420 of FIG. 4, etc. In some aspects, the underwater vehicle can be the same as or similar to one or more of the underwater vehicle 210 of FIGS. 2, 310 of FIGS. 3, 410 of FIG. 4, etc.

At block 504, the process 500 can include performing a measurement cycle of a sub-bottom profiler (SBP) system in response to transmission of the sonar pulse by the sonar transducer array, wherein the SBP system is associated with an underwater vehicle. Performing the measurement cycle of the SBP system at block 504 can comprise transmitting, using a transmitter of the SBP system, an acoustic pulse, wherein the transmitter of the SBP system is triggered based on the transmission of the sonar pulse by the sonar transducer array, and obtaining, using a plurality of receivers of the SBP system, respective acoustic measurement data corresponding to reflections of the acoustic pulse, wherein the plurality of receivers of the SBP system are rigidly coupled to the underwater vehicle and arranged in a linear configuration with the transmitter of the SBP system.

For example, the SBP system can be the same as or similar to one or more of the SBP system of FIG. 2, comprising the SBP transmitter 230 and the SBP receiver 232; the SBP system of FIG. 3, comprising the SBP transmitter 330 and the plurality of SBP receivers 332-1, 332-2, 332-3, 332-4; and/or the SBP system of FIG. 4, comprising the SBP transmitter 430 and the plurality of SBP receivers 432-1, 432-2, 432-3, 432-4; etc. In some examples, the acoustic measurement data corresponding to reflections of the acoustic pulse as received by each respective SBP receiver of the plurality of SBP receivers can be SBP profile data. For example, the acoustic measurement data can be the same as or similar to the SBP data 280 obtained by the SBP receiver 232 as a reflection of a transmitted pulse from the SBP transmitter 230.

In some cases, the acoustic measurement data can be the same as or similar to the respective first SBP data 380-1, obtained by the first SBP receiver 332-1 based on a first reflection of the transmitted pulse from the SBP transmitter 330; the respective second SBP data 380-2, obtained by the second SBP receiver 332-2 based on a second reflection of the transmitted pulse from the SBP transmitter 330; the respective third SBP data 380-3, obtained by the third SBP receiver 332-3 based on a third reflection of the transmitted pulse from the SBP transmitter 330; and the respective fourth SBP data 380-4, obtained by the fourth SBP receiver 332-4 based on a fourth reflection of the transmitted pulse from the SBP transmitter 330. In some examples, the acoustic measurement data can be the same as or similar to the respective first SBP data 480-1, obtained by the first SBP receiver 432-1 based on a first reflection of the transmitted pulse from the SBP transmitter 430; the respective second SBP data 480-2, obtained by the second SBP receiver 432-2 based on a second reflection of the transmitted pulse from the SBP transmitter 430; the respective third SBP data 480-3, obtained by the third SBP receiver 432-3 based on a third reflection of the transmitted pulse from the SBP transmitter 430; and the respective fourth SBP data 480-4, obtained by the fourth SBP receiver 432-4 based on a fourth reflection of the transmitted pulse from the SBP transmitter 430.

In some cases, a duration of the measurement cycle of the SBP system is less than or equal to a duration of a transmission cycle of the sonar transducer array. For example, one measurement cycle of the SBP system can be performed within the transmission cycle of the sonar transducer array. In some embodiments, the transmission cycle of the sonar transducer array corresponds to successive sonar pulse transmissions by the sonar transducer array according to the first transmission rate. For example, the first transmission rate can correspond to an array length of an SAS sonar configured as the sonar transducer array. In some cases, the first transmission rate can correspond to a configured distance (e.g., SAS array length) of approximately 180 cm, and the measurement cycle of the SBP system can be performed once every 180 cm or less. In some cases, the process 500 can include obtaining sonar measurement data based on using the sonar transducer array to receive one or more reflections of the transmitted sonar pulse, wherein the sonar transducer array receives the one or more reflections of the transmitted sonar pulse at a time after the transmission of the acoustic pulse by the transmitter of the SBP system is completed.

In some examples, the sonar transducer array comprises a synthetic aperture sonar (SAS) transducer array oriented in an along-track direction corresponding to a direction of travel of the underwater vehicle. In some cases, a periodicity between successive measurement cycles of the SBP system corresponds to a length of the sonar transducer array. In some embodiments, the sonar transducer array and the SBP system are oriented perpendicular to one another on the underwater vehicle. In some examples, the underwater vehicle comprises at least one of: a surface vessel, an underwater vessel, an underwater platform, or an uncrewed underwater vessel (UUV). In some cases, the underwater vehicle comprises a remote operated vehicle (ROV) or an autonomous underwater vehicle (AUV). In some embodiments, the underwater vehicle can be the same as or similar to one or more of the underwater vehicle 210 of FIGS. 2, 310 of FIG. 3, and/or 410 of FIG. 4, etc.

In some aspects, the first transmission rate of the sonar transducer array is based on the configured distance along the seafloor surface and a survey speed of the underwater vehicle. In some cases, the survey speed is greater than 4 meters per second. In some examples, the survey speed is greater than 1.6 meters per second. In some cases, a survey speed of 1.6 meters per second can be referred to as a baseline survey speed. The survey speed of the underwater vehicle of process 500 can be greater than the baseline survey speed, and can be referred to as a high-speed survey speed. In some embodiments, the plurality of receivers of the SBP system and the transmitter of the SBP system are arranged in the linear configuration oriented along an along-track axis of the underwater vehicle. For example, the linear configuration can correspond to the first configuration of the SBP system transmitter 330 and plurality of SBP receivers 332-1, 332-2, 332-3, 332-4 shown in FIG. 3, where the SBP transmitter 330 is disposed between the pair of SBP receivers 332-1, 332-2 to the rear and the pair of SBP receivers 332-3, 332-4 toward the front in the direction of travel of the underwater vehicle 310. In some examples, the linear configuration can correspond to the second configuration of the SBP system transmitter 430 and the plurality of SBP receivers 432-1, 432-2, 432-3, 432-4 shown in the example of FIG. 4, where the SBP transmitter 430 is disposed between the three SBP receivers 432-1, 432-2, 432-3 toward the rear of the underwater vehicle 410, and the fourth SBP receivers 432-4 toward the front of the underwater vehicle 410, in the direction of the travel of the underwater vehicle 410.

In some examples, the process 500 can include obtaining inertial measurement data associated with the underwater vehicle, wherein at least a portion of the inertial measurement data corresponds to one or more movements of the underwater vehicle during the measurement cycle of the SBP system. For example, the inertial measurement data associated with the underwater vehicle can be the same as or similar to inertial measurement data obtained from the INS, IMU, and/or orientation sensors 340 of the underwater vehicle 310 of FIG. 3; can be the same as or similar to the inertial measurement data obtained from the INS, IMU, and/or orientation sensors 440 of the underwater vehicle 410 of FIG. 4; etc.

In some aspects, the process 500 further includes obtaining multi-channel SBP measurement data corresponding to a plurality of measurement cycles of the SBP system, wherein each channel of the multi-channel SBP measurement data includes the respective acoustic measurement data obtained during the plurality of measurement cycles using a respective receiver of the plurality of receivers of the SBP system. In some embodiments, obtaining the multi-channel SBP measurement data can correspond to performing the plurality of measurement cycles of the SBP system, wherein each measurement cycle of the plurality of measurement cycles of the SBP system are based on performing blocks 502 and 504 of the process 500.

In some aspects, the process 500 further includes correlating the multi-channel SBP measurement data with the inertial measurement data to determine respective motion compensation information for each channel of the multi-channel SBP measurement data, and processing the multi-channel SBP measurement data according to the respective motion compensation information for each channel, to thereby generate a processed sub-bottom profile for the plurality of measurement cycles of the SBP system. In some embodiments, a spatial measurement density of the processed sub-bottom profile is greater than a spatial transmission density associated with the SBP system transmitting one acoustic pulse within each measurement cycle of the plurality of measurement cycles. In some cases, the spatial measurement density of the processed sub-bottom profile is greater than the spatial transmission density by a factor equal to a quantity of receivers included in the plurality of receivers of the SBP system.

In some aspects, a spatial resolution of the processed sub-bottom profile is equal to the configured distance along the seafloor surface divided by a quantity of receivers included in the plurality of receivers of the SBP system. In some examples, the process 500 further includes determining, for each respective measurement cycle of the plurality of measurement cycles, a normalized horizontal plane corresponding to the linear configuration of the plurality of receivers and the transmitter of the SBP system during the respective measurement cycle, wherein the normalized horizontal plane is determined based on the inertial measurement data associated with the underwater vehicle. In some embodiments, processing the multi-channel SBP measurement data according to the respective motion compensation information for each channel includes: using the respective motion compensation information for each channel to align the acoustic measurement data for each receiver of the SBP system to the normalized horizontal plane determined for the respective measurement cycle.

In some cases, the respective motion compensation information for each channel of the multi-channel SBP measurement data is indicative of a corresponding three-dimensional (3D) coordinate for the respective receiver of the SBP system at a time when the respective receiver obtained the respective acoustic measurement data for each measurement cycle of the plurality of measurement cycles. In some examples, the inertial measurement data is obtained using an inertial navigation system (INS) of the underwater vehicle, and the respective motion compensation information for each channel is determined based on projecting the inertial measurement data from a position of the INS on the underwater vehicle to a corresponding position on the underwater vehicle of the respective receiver of the SBP system associated with each channel.

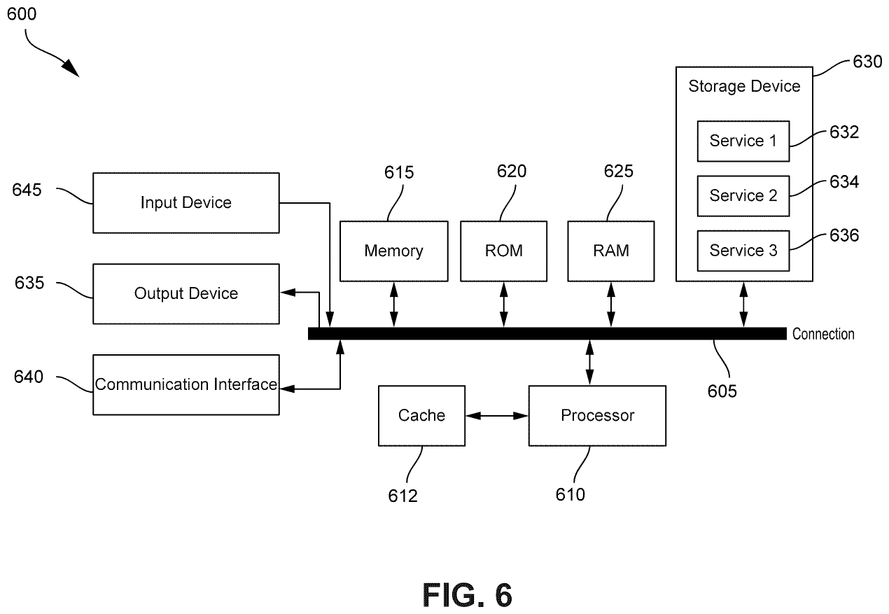

FIG. 6 is a diagram illustrating an example of a system for implementing certain aspects of the present technology. In particular, FIG. 6 illustrates an example of computing system 600, which may be for example any computing device making up internal computing system, a remote computing system, a camera, or any component thereof in which the components of the system are in communication with each other using connection 605. Connection 605 may be a physical connection using a bus, or a direct connection into processor 610, such as in a chipset architecture. Connection 605 may also be a virtual connection, networked connection, or logical connection.

In some aspects, computing system 600 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 600 includes at least one processing unit (CPU or processor) 610 and connection 605 that communicatively couples various system components including system memory 615, such as read-only memory (ROM) 620 and random access memory (RAM) 625 to processor 610. Computing system 600 may include a cache 612 of high-speed memory connected directly with, in close proximity to, or integrated as part of processor 610.

Processor 610 may include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which may represent any number of input mechanisms, such as a microphone for speech, a touch-sensitive screen for gesture or graphical input, keyboard, mouse, motion input, speech, etc. Computing system 600 may also include output device 635, which may be one or more of a number of output mechanisms. In some instances, multimodal systems may enable a user to provide multiple types of input/output to communicate with computing system 600.

Computing system 600 may include communications interface 640, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1 ) cache, Level 2 (L2 ) cache, Level 3 (L3 ) cache, Level 4 (L4 ) cache, Level 5 (L5 ) cache, or other (L#) cache), resistive random-access memory (RRAM/ReRAM), phase change memory (PCM), spin transfer torque RAM (STT-RAM), another memory chip or cartridge, and/or a combination thereof.

The storage device 630 may include software services, servers, services, etc., that when the code that defines such software is executed by the processor 610, it causes the system to perform a function. In some aspects, a hardware service that performs a particular function may include the software component stored in a computer-readable medium in connection with the necessary hardware components, such as processor 610, connection 605, output device 635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

1. A method comprising:
transmitting a sonar pulse using a sonar transducer array, wherein the sonar transducer array transmits the sonar pulse according to a first transmission rate, and wherein the first transmission rate corresponds to a configured distance along a seafloor surface; and
performing a measurement cycle of a sub-bottom profiler (SBP) system in response to transmission of the sonar pulse by the sonar transducer array, wherein the SBP system is associated with an underwater vehicle, and wherein performing the measurement cycle comprises:
transmitting, using a transmitter of the SBP system, an acoustic pulse, wherein the transmitter of the SBP system is triggered based on the transmission of the sonar pulse by the sonar transducer array; and
obtaining, using a plurality of receivers of the SBP system, respective acoustic measurement data corresponding to reflections of the acoustic pulse, wherein the plurality of receivers of the SBP system are rigidly coupled to the underwater vehicle and arranged in a linear configuration with the transmitter of the SBP system.

2. The method of claim 1, further comprising:
obtaining multi-channel SBP measurement data corresponding to a plurality of measurement cycles of the SBP system,
wherein each channel of the multi-channel SBP measurement data includes the respective acoustic measurement data obtained during the plurality of measurement cycles using a respective receiver of the plurality of receivers of the SBP system.

3. The method of claim 2, further comprising:
obtaining inertial measurement data associated with the underwater vehicle, wherein at least a portion of the inertial measurement data corresponds to one or more movements of the underwater vehicle during the measurement cycle of the SBP system;
correlating the multi-channel SBP measurement data with the inertial measurement data to determine respective motion compensation information for each channel of the multi-channel SBP measurement data; and
processing the multi-channel SBP measurement data according to the respective motion compensation information for each channel, to thereby generate a processed sub-bottom profile for the plurality of measurement cycles of the SBP system.

4. The method of claim 3, wherein a spatial measurement density of the processed sub-bottom profile is greater than a spatial transmission density associated with the SBP system transmitting one acoustic pulse within each measurement cycle of the plurality of measurement cycles.

5. The method of claim 3, further comprising:
determining, for each respective measurement cycle of the plurality of measurement cycles, a normalized horizontal plane corresponding to the linear configuration of the plurality of receivers and the transmitter of the SBP system during the respective measurement cycle, wherein the normalized horizontal plane is determined based on the inertial measurement data associated with the underwater vehicle.

6. The method of claim 5, wherein processing the multi-channel SBP measurement data according to the respective motion compensation information for each channel includes:
using the respective motion compensation information for each channel to align the acoustic measurement data for each receiver of the SBP system to the normalized horizontal plane determined for the respective measurement cycle.

7. The method of claim 3, wherein the respective motion compensation information for each channel of the multi-channel SBP measurement data is indicative of:
a corresponding three-dimensional (3D) coordinate for the respective receiver of the SBP system at a time when the respective receiver obtained the respective acoustic measurement data for each measurement cycle of the plurality of measurement cycles.

8. The method of claim 3, wherein:
the inertial measurement data is obtained using an inertial navigation system (INS) of the underwater vehicle; and
the respective motion compensation information for each channel is determined based on projecting the inertial measurement data from a position of the INS on the underwater vehicle to a corresponding position on the underwater vehicle of the respective receiver of the SBP system associated with each channel.

9. The method of claim 1, wherein:
a duration of the measurement cycle of the SBP system is less than or equal to a duration of a transmission cycle of the sonar transducer array; and
the transmission cycle of the sonar transducer array corresponds to successive sonar pulse transmissions by the sonar transducer array according to the first transmission rate.

10. The method of claim 1, wherein the sonar transducer array comprises a synthetic aperture sonar (SAS) transducer array oriented in an along-track direction corresponding to a direction of travel of the underwater vehicle.

11. The method of claim 1, wherein the plurality of receivers of the SBP system and the transmitter of the SBP system are arranged in the linear configuration oriented along an along-track axis of the underwater vehicle.

12. An underwater vehicle for marine surveying, the underwater vehicle comprising:
a sub-bottom profiler (SBP) transmitter included in a multi-receiver SBP system of the underwater vehicle; and
a plurality of SBP receivers included in the multi-receiver SBP system of the underwater vehicle, wherein the plurality of SBP receivers are rigidly coupled to the underwater vehicle and arranged in a linear configuration positioned longitudinally along a direction of travel of the underwater vehicle.

13. The underwater vehicle of claim 12, wherein the underwater vehicle further comprises:
a flat panel array rigidly coupled to an exterior surface of the underwater vehicle, wherein the flat panel array extends longitudinally along the direction of travel of the underwater vehicle, and wherein the plurality of SBP receivers are attached to the flat panel array in the linear configuration.

14. The underwater vehicle of claim 13, wherein the flat panel array comprises a rigid housing for the plurality of SBP receivers of the multi-receiver SBP system.

15. The underwater vehicle of claim 12, wherein the plurality of SBP receivers are integral with an exterior surface of the underwater vehicle based on the plurality of SBP receivers being rigidly coupled to the underwater vehicle.

16. The underwater vehicle of claim 12, further comprising a controller associated with the multi-receiver SBP system, wherein the controller is configured to perform a measurement cycle of the SBP system in response to transmission of a sonar pulse by a sonar transducer array having a first transmission rate corresponding to a configured distance along a seafloor surface.

17. The underwater vehicle of claim 16, wherein the sonar transducer array comprises a synthetic aperture sonar (SAS) transducer array or a side scan sonar (SSS) transducer array.

18. The underwater vehicle of claim 16, wherein:
the controller is included in the multi-receiver SBP system; and
to perform the measurement cycle of the SBP system, the controller is configured to: trigger the SBP transmitter to emit an acoustic pulse, wherein the controller triggers the SBP transmitter in response to the transmission of the sonar pulse by the sonar transducer array.

19. The underwater vehicle of claim 16, wherein the sonar transducer array is included in the underwater vehicle.

20. The underwater vehicle of claim 12, wherein the SBP transmitter is included in the linear configuration.
